(19) United States
(12) Patent Application Publication
(10) Pub. No.: US 2012/0147232 A1
(43) Pub. Date: Jun. 14, 2012

(54) IMAGING APPARATUS

(75) Inventors: Tomohiko Takayama, Kawasaki-shi (JP); Toru Sasaki, Yokohama-shi (JP)

(73) Assignee: CANON KABUSHIKI KAISHA, Tokyo (JP)

(21) Appl. No.: 13/302,367

(22) Filed: Nov. 22, 2011

(30) Foreign Application Priority Data
Dec. 8, 2010 (JP) 2010-273386
Aug. 24, 2011 (JP) 2011-183091

(51) Int. Cl. H04N 5/335

(52) U.S. Cl. 348/294

(57) ABSTRACT

An imaging apparatus has two-dimensional image sensors which are discretely disposed, an imaging optical system which enlarges an image of an object and forms an image thereof on an imaging plane of the two-dimensional image sensors, and a moving unit which moves the object in order to execute a plurality of times of imaging while changing the divided area to be imaged by each of the two-dimensional image sensors. At least a part of the plurality of divided areas is deformed or displaced on the imaging plane due to aberration of the imaging optical system. Each position of the two-dimensional image sensors is adjusted according to a shape and position of the corresponding divided area on the imaging plane.

### BACKGROUND OF THE INVENTION

1. Field of the Invention

The present invention relates to an imaging apparatus, and more particularly to an imaging apparatus which divides and images an area using a plurality of image sensors which are discretely arranged.

2. Description of the Related Art

In the field of pathology, a virtual slide apparatus is available, where a sample placed on a slide is imaged, and the image is digitized so as to make possible a pathological diagnosis based on a display. This is used instead of an optical microscope, which is another tool used for pathological diagnosis. By digitizing an image for pathological diagnosis using a virtual slide apparatus, a conventional optical microscope image of the sample can be handled as digital data. The expected merits of this are: a quick remote diagnosis, a description of a diagnosis for a patient using digital images, a sharing of rare cases, and making education and practical training efficient.

In order to digitize the operation with an optical microscope using the virtual slide apparatus, the entire sample on the slide must be digitized. By digitizing the entire sample, the digital data created by the virtual slide apparatus can be observed by viewer software, which runs on a PC and WS. If the entire sample is digitized, however an enormous number of pixels are required, normally several hundred million to several billion. Therefore in a virtual slide apparatus, an area of a sample is divided into a plurality of areas, and is imaged using a two-dimensional image sensor having several hundred thousand to several million pixels, or using a one-dimensional image sensor having several thousand pixels. To implement divided imaging, it is necessary to tile (merge) a plurality of divided images so as to generate an entire image of the test sample.

The tiling method using one two-dimensional image sensor captures images of a test sample for a plurality of times while moving the two-dimensional image sensor relative to the test sample, and acquires the entire image of the test sample by pasting the plurality of captured images together without openings. A problem of the tiling method using a single two-dimensional image sensor is that it takes more time in capturing images as a number of divided areas increases in the sample.

As a technology to solve this problem, the following technology has been proposed (see Japanese Patent Application Laid-Open No. 2009-003016). Japanese Patent Application Laid-Open No. 2009-003016 discloses a technology which includes a microscope having an image sensor group formed of a plurality of two-dimensional image sensors disposed within the field of view of an objective lens, and images an entire screen by capturing the images a plurality of number of times while relatively changing the positions of the image sensor group and the position of the sample.

In the microscope disclosed in Japanese Patent Application Laid-Open No. 2009-003016, the plurality of two-dimensional image sensors are equally spaced. In the case of the imaging area on the object plane being projected onto the imaging plane of the image sensor group without distortion, image data can be efficiently generated by equally spacing the two-dimensional image sensors. In reality however, the imaging area on the imaging plane is distorted as shown in FIG. 11, due to the distortion of the imaging optical system. This can be interpreted that the divided areas to be imaged by the respective two-dimensional image sensors are unequally spaced in a distorted form. In order to image the distorted divided areas on the imaging plane using the equally spaced two-dimensional image sensors, it is necessary to increase the imaging area 1102 of each of the two-dimensional image sensors so as to include the distorted divided area 1101, as shown in FIG. 11. Therefore image data as well, which does not contribute to image merging, must be obtained, so image data generation efficiency may drop if the influence of the distortion of the imaging optical system is major.

### SUMMARY OF THE INVENTION

With the foregoing in view, it is an object of the present invention to provide a configuration to divide an area and to image the divided areas using a plurality of image sensors which are discretely disposed, so as to efficiently obtain the image data of each of the divided areas.

The present invention in its first aspect provides an imaging apparatus which, with an imaging target area of an object being divided into a plurality of areas, images each of the divided areas using a two-dimensional image sensor, the apparatus including: a plurality of two-dimensional image sensors which are discretely disposed; an imaging optical system which enlarges an image of the object and forms an image thereof on an imaging plane of the plurality of two-dimensional image sensors; and a moving unit which moves the object in order to execute a plurality of times of imaging while changing the divided area to be imaged by each of the two-dimensional image sensors, wherein at least a part of the plurality of divided areas is deformed or displaced on the imaging plane due to aberration of the imaging optical system, and each position of the plurality of two-dimensional image sensors is adjusted according to a shape and position of the corresponding divided area on the imaging plane.

The present invention in its second aspect provides an imaging apparatus which, with an imaging target area of an object being divided into a plurality of areas, images each of the divided areas using a two-dimensional image sensor, including: a plurality of two-dimensional image sensors which are discretely disposed; an imaging optical system which enlarges an image of the object and forms an image thereof on an imaging plane of the plurality of two-dimensional image sensors; a moving unit which moves the object in order to execute a plurality of times of imaging while changing the divided area to be imaged by each of the two-dimensional image sensors, and a position adjustment unit which adjusts each position of the plurality of two-dimensional image sensors, wherein at least a part of the plurality of divided areas is deformed or displaced on the imaging plane due to aberration of the imaging optical system, and when aberration of the imaging optical system changes, the position adjustment unit changes a position of each of the two-dimensional image sensors according to the deformation or displacement of each divided area due to the aberration after change.

According to the present invention, a configuration, to divide an area and to image the divided areas using a plurality of image sensors which are discretely disposed, can be provided so as to efficiently obtain the image data of each of the divided areas.

Further features of the present invention will become apparent from the following description of exemplary embodiments with reference to the attached drawings.

### BRIEF DESCRIPTION OF THE DRAWINGS

FIGS. 1A to 1C are schematic diagrams depicting a general configuration related to imaging of a digital slide scanner;

FIGS. 2A and 2B are schematic diagrams depicting a configuration of a two-dimensional image sensor;

FIGS. 3A and 3B are schematic diagrams depicting an aberration of an imaging optical system;

FIG. 4 is a schematic diagram depicting an arrangement of the two-dimensional image sensors;

FIGS. 5A and 5B are schematic diagrams depicting an imaging sequence;

FIGS. 6A and 6B are flow charts depicting image data reading;

FIGS. 7A to 7C are schematic diagrams depicting a read area according to distortion;

FIG. 8 is a flow chart depicting image data reading according to chromatic aberration of magnification;

FIG. 9 is a schematic diagram depicting a configuration for electrically controlling a reading range of each image sensor;

FIG. 10 is a schematic diagram depicting a configuration for mechanically adjusting a position of each image sensor; and

FIG. 11 is a schematic diagram depicting a problem.

### DESCRIPTION OF THE EMBODIMENTS

### First Embodiment

### Configuration of Imaging Apparatus

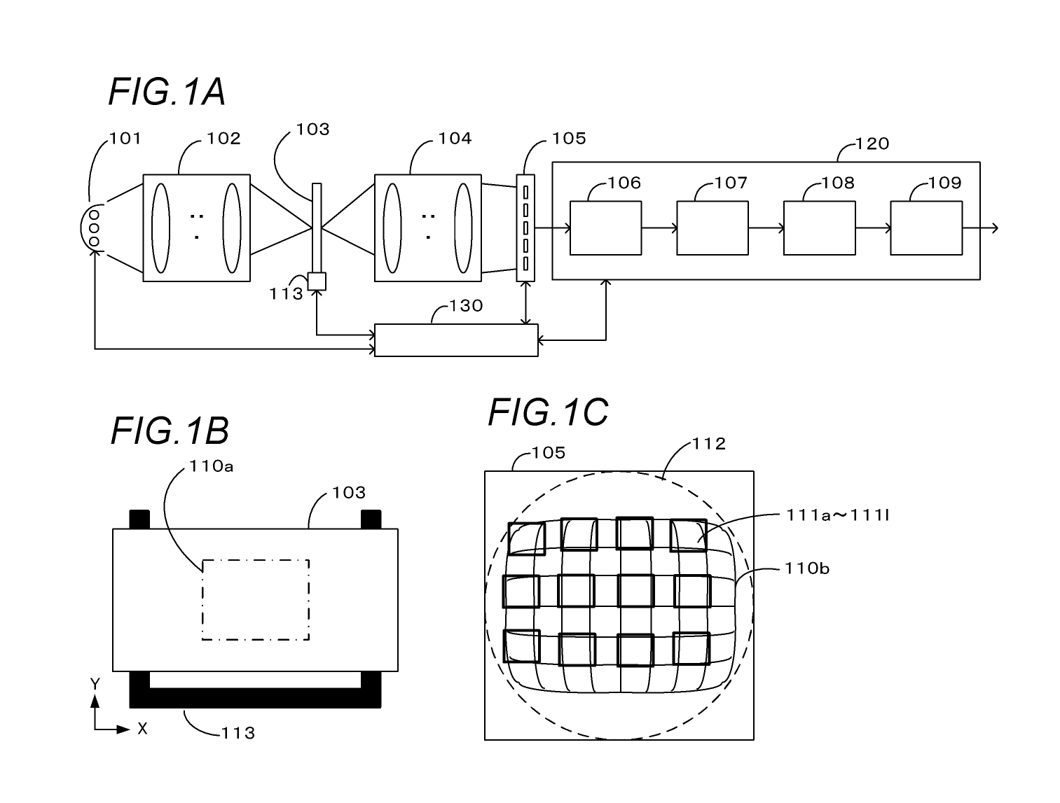

FIG. 1A to FIG. 1C are schematic diagrams depicting a general configuration of an imaging apparatus according to a first embodiment of the present invention. This imaging apparatus is an apparatus for obtaining an optical microscopic image of a test sample on a slide 103, which is an object, as a high resolution large size (wide angle of view) digital image.

FIG. 1A is a schematic diagram depicting a general configuration of the imaging apparatus. The imaging apparatus is comprised of a light source 101, an illumination optical system 102, an imaging optical system 104, a moving mechanism 113, an imaging unit 105, an image processing unit 120 and a control unit 130. The image processing unit 120 has such functional blocks as a development/correction unit 106, a merging unit 107, a compression unit 108 and a transmission unit 109. Operation and timing of each component of the imaging apparatus are controlled by the control unit 130.

The light source 101 is a unit for generating an illumination light for imaging. For the light source 101, a light source having emission wavelengths of three colors, RGB, is used, such as a light source with a configuration of emitting light by electrically switching each monochromatic light using an LED, LD or the like, or a light source with a configuration of mechanically switching each monochromatic light using a white LED and color wheel. In this case, monochrome image sensors, which have no color filters, are used for the image sensor group of the imaging unit 105. The light source 101 and the imaging unit 105 operate synchronously. The light source 101 sequentially emits the lights of RGB, and the imaging unit 105 exposes and acquires each RGB image respectively, synchronizing with the emission timings of the light source 101. One captured image is generated from each RGB image by the development/correction unit 106 in the subsequent step. The illumination optical system 102 guides the light of the light source 101 efficiently to an imaging reference area 110a on the slide 103.

The slide (preparation) 103 is a supporting plate to support a sample to be a target of pathological diagnosis. And the slide 103 has a slide glass on which the sample is placed and a cover glass with which the sample is sealed using a mounting solution.

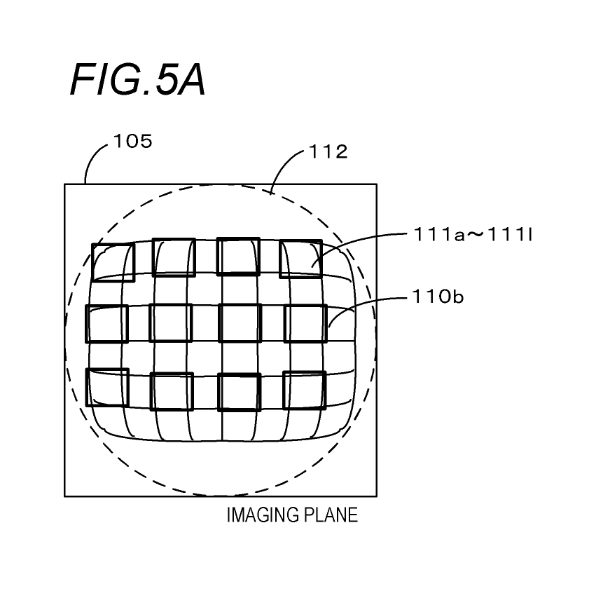

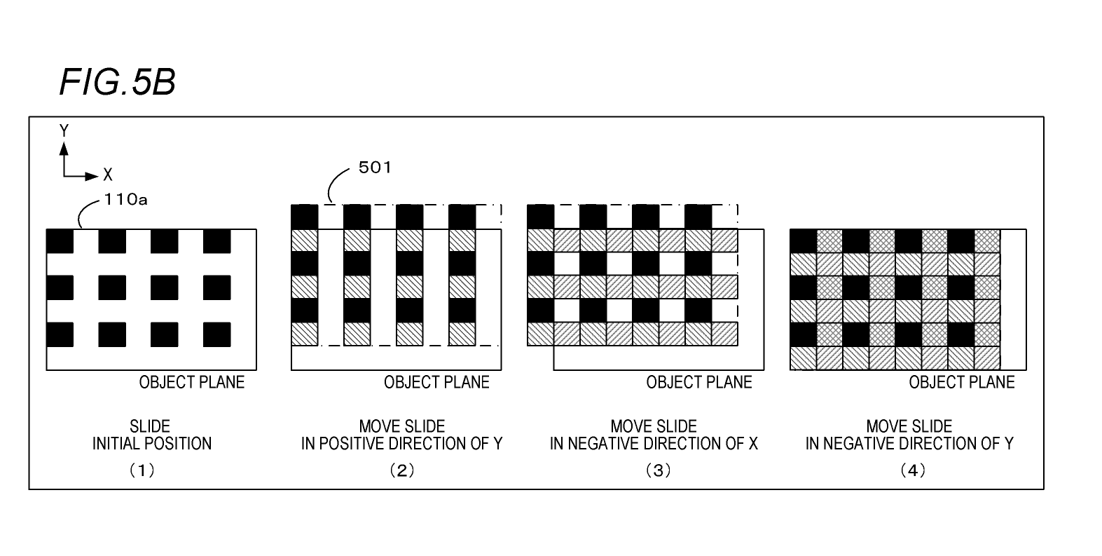

FIG. 1B illustrates the slide 103 and an imaging reference area 110a. The imaging reference area 110a is an area which exists as a reference position on the object plane, regardless the position of the slide. The imaging reference area 110a is an area fixed with respect to the imaging optical system 104, which is disposed in a fixed position, but the relative positional relationship with respect to the slide 103 changes according to the movement of the slide 103. For an area of a test sample on the slide 103, an imaging target area 501 (described later) is defined, separately from the imaging reference area 110a. If the slide 103 is in an initial position (described later), the imaging reference area 110a and the imaging target area 501 match. The imaging target area 501 and the initial position of the slide will be described later with reference to FIG. 5B. A size of the slide 103 is approximately 76 mm×26 mm, and it is assumed here that the size of the imaging reference area 110a is 15 mm×10 mm.

The imaging optical system 104 enlarges (magnifies) and guides transmitted light from the imaging reference area 110a on the slide 103, and forms an image of an imaging reference area image 110b, which is a real image of the imaging reference area 110a, on the imaging plane of the imaging unit 105. Due to the influence of an aberration of the imaging optical system 104, the imaging reference area image 110b has been deformed or displaced. Here it is assumed that the imaging reference area image has a form which was deformed into a barrel shape by the distortion. An effective field of view 112 of the imaging optical system 104 is a size which includes the image sensor group 111a to 111l and the imaging reference area image 110b.

The imaging unit 105 is an imaging unit constituted by a plurality of two-dimensional image sensors which are discretely arrayed two-dimensionally in the X direction and the Y direction, with spacing therebetween. In this embodiment, twelve two-dimensional image sensors 111a to 111l arranged in four columns and three rows are provided. These image sensors may be mounted on a same board or on separate boards. To distinguish an individual image sensor, an alphabetic character is attached to the reference number, that is, from a to d, sequentially from the left, in the first row, e to h in the second row, and i to l in the third row, but for simplification, image sensors are denoted as “111a to 111l” in the drawing. This is the same for the other drawings. FIG. 1C illustrates the positional relationships of the image sensor group 111a to 111l in the initial state, the imaging reference area image 110b on the imaging plane and the effective field of view 112 of the imaging optical system.

Since the positional relationship between the image sensor group 111a to 111l and the effective field of view 112 of the imaging optical system is fixed, the positional relationship between the deformed shape of the imaging reference area image 110b on the imaging plane, with respect to the image sensor group 111a to 111l, is also fixed. The positional relationship between the imaging reference area 110a and the imaging target area 501, in the case of imaging the entire area of the imaging target area 501 while moving the imaging target area 501 using the moving mechanism 113 (XY stage) disposed on the slide side, will be described later with reference to FIG. 5B.

The development/correction unit 106 performs the development processing and the correction processing of the digital data acquired by the imaging unit 105. The functions thereof include black level correction, DNR (Digital Noise Reduction), pixel defect correction, brightness correction due to individual dispersion of image sensors and shading, development processing, white balance processing, enhancement processing, and correction of distortion and chromatic aberration of magnification. The merging unit 107 performs processing to merge a plurality of captured images (divided images). Images to be connected are images that are produced after the development/correction unit 106 corrects the distortion and the chromatic aberration of magnification.

The compression unit 108 performs sequential compression processing for each block image which is output from the merging unit 107. The transmission unit 109 outputs the signals of the compressed block image to a PC (Personal Computer) and WS (Workstation). For the signal transmission to a PC and WS, it is preferable to use a communication standard which allows large capacity transmission, such as gigabit Ethernet.

In a PC and WS, each received compressed block image is sequentially stored in a storage. To read a captured image of a sample, viewer software is used. The viewer software reads the compressed block image in the read area, and decompresses and displays the image on a display. By this configuration, a high resolution large screen image can be captured from about a 15 mm×10 mm sample, and the acquired image can be displayed.

Here a configuration of sequentially emitting monochromatic light with the light source 101 to image the object using the monochrome image sensor group 111a to 111l was described, but the light source may be a white LED and the image sensors may be image sensors with color filters.

(Configuration of Image Sensor)

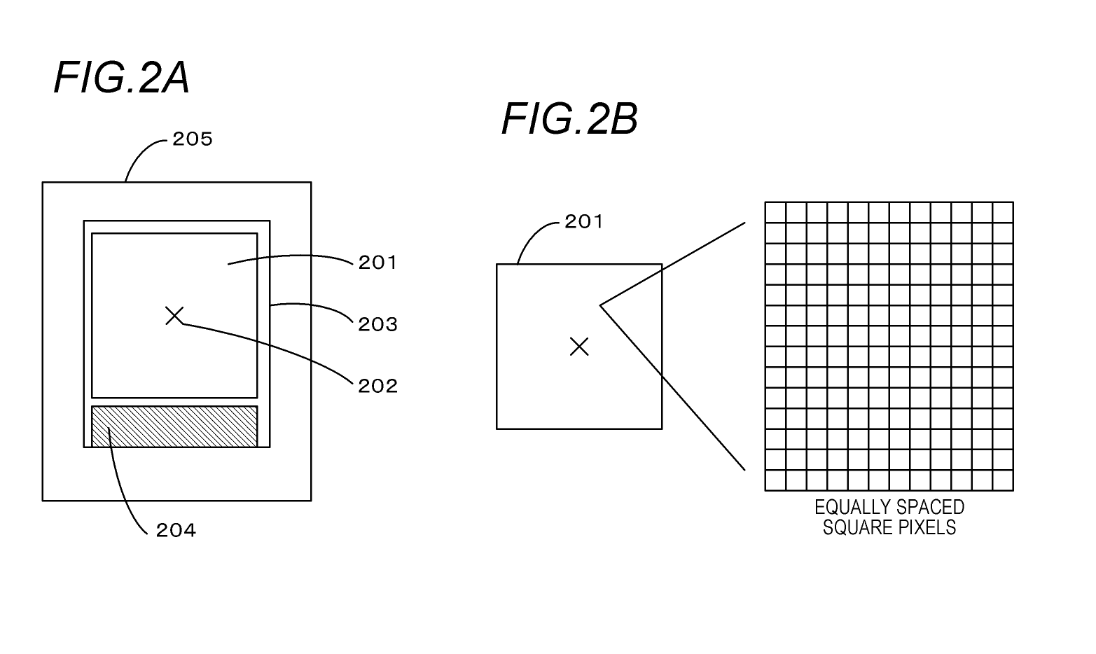

FIG. 2A and FIG. 2B are schematic diagrams depicting a configuration of a two-dimensional image sensor and an effective image plane.

FIG. 2A is a schematic diagram when the two-dimensional image sensor is viewed from the top. 201 is an effective image area, 202 is a center of the effective image area, 203 is a die (image sensor chip), 204 is a circuit unit and 205 is a package frame. The effective image area 201 is an area where effective pixels are disposed, out of a light receiving surface of the two-dimensional image sensor, in other words, in a range where image data is generated. Each area of the image sensor group 111a to 111l shown in FIG. 1C is equivalent to the effective image area 201 in FIG. 2A.

FIG. 2B shows that the effective image plane 201 is constituted by equally spaced square pixels. Another pixel structure (shape and arrangement of pixels) that is known is octagonal pixels disposed alternately in a checkered pattern, but characteristics common to these types of pixel structures are that the pixels have an identical shape, and a same arrangement is repeated.

(Aberration of Imaging Optical System)

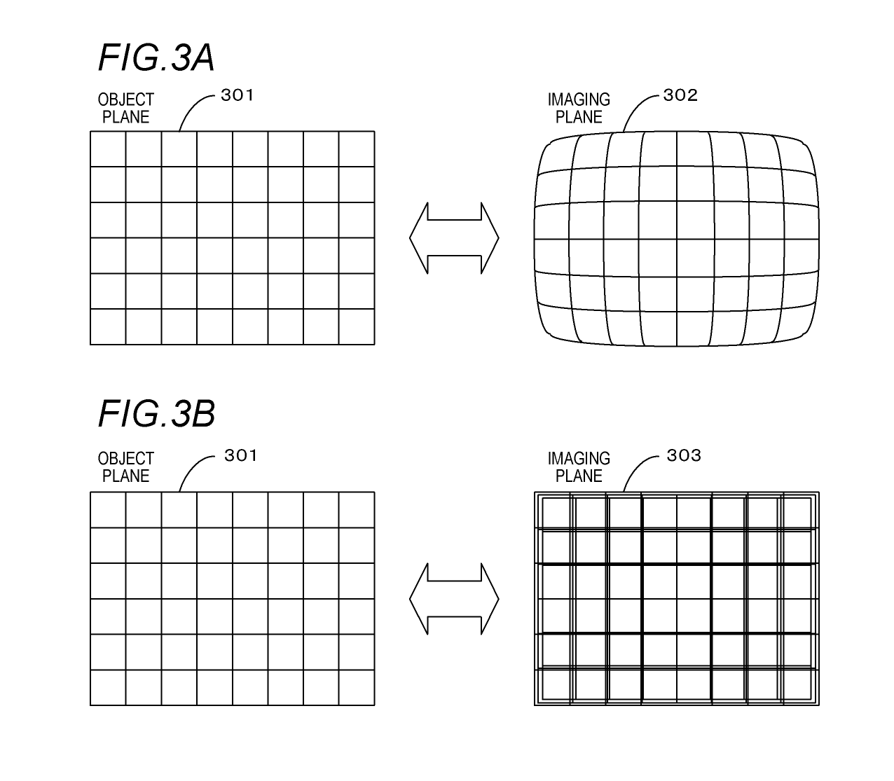

In the imaging optical system 104, various aberrations, such as distortion and chromatic aberration of magnification, can be generated due to the shapes and optical characteristics of the lenses. The phenomena of an image being deformed or displaced due to the aberrations of the imaging optical system will be described with reference to FIG. 3A and FIG. 3B.

FIG. 3A is a schematic diagram depicting distortion. An object plane wire frame 301 is disposed on an object plane (on the slide), and the optical image thereof is observed via the imaging optical system. The object plane wire frame 301 is an imaging target area which is equally spaced and divided in the row direction and the column direction respectively. An imaging plane wire frame 302, of which shape is deformed due to the influence of distortion of the imaging optical system, is observed on the imaging plane (on the effective image plane of the two-dimensional image sensor). Here an example of barrel-shaped distortion is shown. In the case of distortion, an individual divided area to be imaged by the two-dimensional image sensor is not a rectangle but a distorted area. The degree of deformation or displacement of each of the divided areas is zero or can be ignored in the center area of the lens, but is high in the edge portion of the lens. For example, the divided area in the upper left corner is deformed into a shape similar to a rhombus, and is displaced toward the center of the lens, compared with the original position (ideal position without aberration). Therefore imaging considering deformation and displacement due to aberrations is required at least for a part of the divided areas, such as an edge portion of the lens.

FIG. 3B is a schematic diagram depicting chromatic aberration of magnification. The chromatic aberration of magnification is a shift of the image (difference of magnification) depending on the color, which is generated due to the difference of refractive indices depending on the wavelength of a ray. If the object plane wire frame 301 on the object plane is observed via the imaging optical system, image plane wire frames 303, having different sizes (magnifications) depending on the color, are observed on the imaging plane (on the effective imaging area of the two-dimensional image sensors). Here an example of three imaging plane wire frames 303 of R, G and B is shown. In the center portion of the lens, the divided areas of R, G and B are approximately in a same position, but the amount of displacement due to aberration increases as the divided areas become closer to the edge portion of the lens, where the shift of the divided areas of R, G and B increases. In the case of chromatic aberration of magnification, the position of the area to be imaged by the two-dimensional image sensor differs depending on the color (each of R, G and B). Therefore imaging, considering the shift of images due to aberrations depending on the color, is required at least for a part of the divided areas, such as edge portions of the lens.

(Arrangement of Image Sensors)

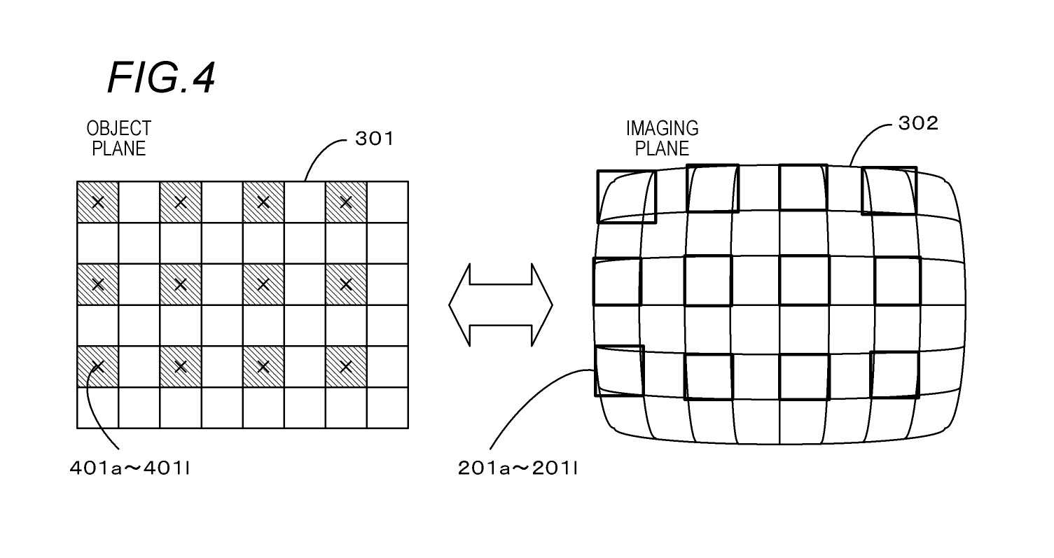

FIG. 4 is a schematic diagram depicting an arrangement of the two-dimensional image sensors considering distortion.

The object plane wire frame 301 on the object plane (on the slide) is observed on the imaging plane (on the effective image area of the two-dimensional image sensors) as the imaging plane wire frame 302, that is deformed to be barrel-shaped due to the influence of distortion. The oblique line areas on the object plane indicate divided areas imaged by the two-dimensional image sensors respectively. The divided areas on the object plane are equally spaced rectangles which have a same size, but on the imaging plane where the image sensor group is disposed, divided areas having deformed shapes are unequally spaced. Normally the test sample on the object plane is formed on the imaging plane as an inverted image, but in order to clearly show the correspondence of the divided areas, the object plane and the imaging plane are illustrated as if they were in an erecting relationship.

Now each position of the effective image areas 201a to 2011 of the two-dimensional image sensors is adjusted according to the shape and position of the corresponding divided area (divided area to be imaged) on the imaging plane. In concrete terms, each position of the two-dimensional image sensors is determined so that each projection center 401a to 401l, which is a center of each effective image area 201a to 201l of the two-dimensional image sensor being projected on the object plane, matches with the center of the corresponding divided area on the object plane. In other words, as shown in FIG. 4 the two-dimensional image sensors on the imaging plane are intentionally arranged (physical arranged) with unequal spaces, so that the images of the equally spaced divided areas on the object plane are received at the centers of the effective image areas respectively.

The size of the two-dimensional image sensor (size of each effective image area 201a to 201l) is determined such that at least the effective image area includes the corresponding divided area. The sizes of the two-dimensional image sensors in this case may be the same or different from one another. In the present invention, the latter configuration is used, that is the sizes of the effective image area of individual two-dimensional image sensors are different according to the size of the corresponding divided area on the imaging plane. Since the shapes of the divided areas are distorted on the imaging plane, the size of the circumscribed rectangle of the divided area is defined as the size of the divided area. In concrete terms, the size of the effective image area of each two-dimensional image sensor is set to be the same size as the circumscribed rectangle of the divided area on the imaging plane, or a size of the circumscribed rectangle around which a predetermined width of a margin required for merging processing is added.

The arrangement of each of the two-dimensional image sensors should be performed during adjustment of the product at the factory, for example, while calculating the center of the arrangement of the two-dimensional image sensor and the size of the two-dimensional image sensor in advance, based on the design values or measured values of distortion.

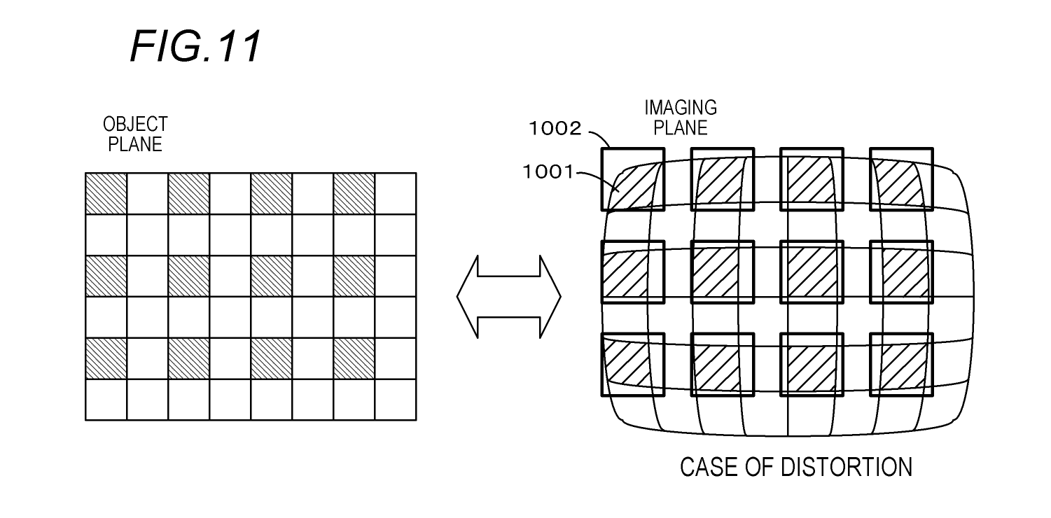

By adjusting the arrangement and the size of each of the two-dimensional image sensors considering aberrations of the imaging optical system, as described above, the effective image area of the two-dimensional image sensor can be efficiently used. As a result, image data required for merging images can be obtained using smaller sized two-dimensional image sensors compared with the prior art (FIG. 11). Since the size and the spacing of the divided areas on the object plane are uniform, and based on this, the arrangement of the two-dimensional image sensors on the imaging plane side is adjusted, feed control of the object in the divided imaging can involve simple equidistant moving. The divided imaging procedure will now be described.

(Procedure of Divided Imaging)

FIG. 5A and FIG. 5B are schematic diagrams depicting a flow of imaging the entire imaging target area by performing a plurality of times of imaging. Here the imaging reference area 110a and the imaging target area 501 will be described. The imaging reference area 110a is an area which exists as a reference position on the object plane, regardless the movement of the slide. The imaging target area 501 is an area where a test sample placed on the slide exists.

FIG. 5A is a schematic diagram of the positional relationship of the image sensor group 111a to 111l and the imaging reference area image 110b on the imaging plane. The imaging reference area image 110b on the imaging plane is not a rectangle, but is distorted into a barrel-shaped area due to the influence of distortion of the imaging optical system 104.

(1) to (4) of FIG. 5B are diagrams depicting a transition of the imaging of the imaging target area 501 by the image sensor group 111a to 111l when the slide is moved by the moving mechanism disposed on the slide side. As FIG. 5A shows, the positional relationship of the image sensor group 111a to 111l and the effective field of view 112 of the imaging optical system is fixed, therefore the shape of distortion of the imaging optical system, with respect to the image sensor group 111a to 111l, is fixed. When the entire area is imaged while moving the slide (imaging target area 501), it is simple to consider equidistant moving of the imaging target area 501 on the object plane, as (1) to (4) in FIG. 5B shows, so that distortion need not be considered. Actually distortion correction that is appropriate for each image sensor is required in the development/correction unit 106 after imaging each divided area by the image sensor group 111a to 111l, however it is sufficient to consider a manner of imaging the entire imaging target area 501 without any opening on the object plane alone.

(1) of FIG. 5B shows areas obtained in the first imaging by solid black squares. In the first imaging position (initial position), each of the R, G and B images are obtained by switching the emission wavelength of the light source. If the slide is in the initial position, the imaging reference area 110a (solid line) and the imaging target area 501 (dashed line) match. (2) shows areas obtained in the second imaging after the moving mechanism moved the slide in the positive direction of the Y axis, which are indicated by oblique lines (slanted to the left). (3) shows areas obtained in the third imaging after the moving mechanism moved the slide in the negative direction of the X axis, which are indicated by the reverse oblique lines (slanted to the right), and (4) shows areas obtained in the fourth imaging after the moving mechanism moved the slide in the negative direction of the Y axis, which are indicated by half tones.

In order to perform the merging processing in a post-stage by a simple sequence, it is assumed that a number of reading pixels in the Y direction is approximately the same for all the divided areas which exist side by side in the X direction on the object plane. For the merging unit 107 to perform merging processing, an overlapped area (margin) is required between adjacent image sensors, but an overlapped area is omitted here to simplify description.

As described above, the entire imaging target area can be imaged without opening by performing imaging processing four times (moving mechanism moves the slide three times) using the image sensor group.

(Imaging Processing)

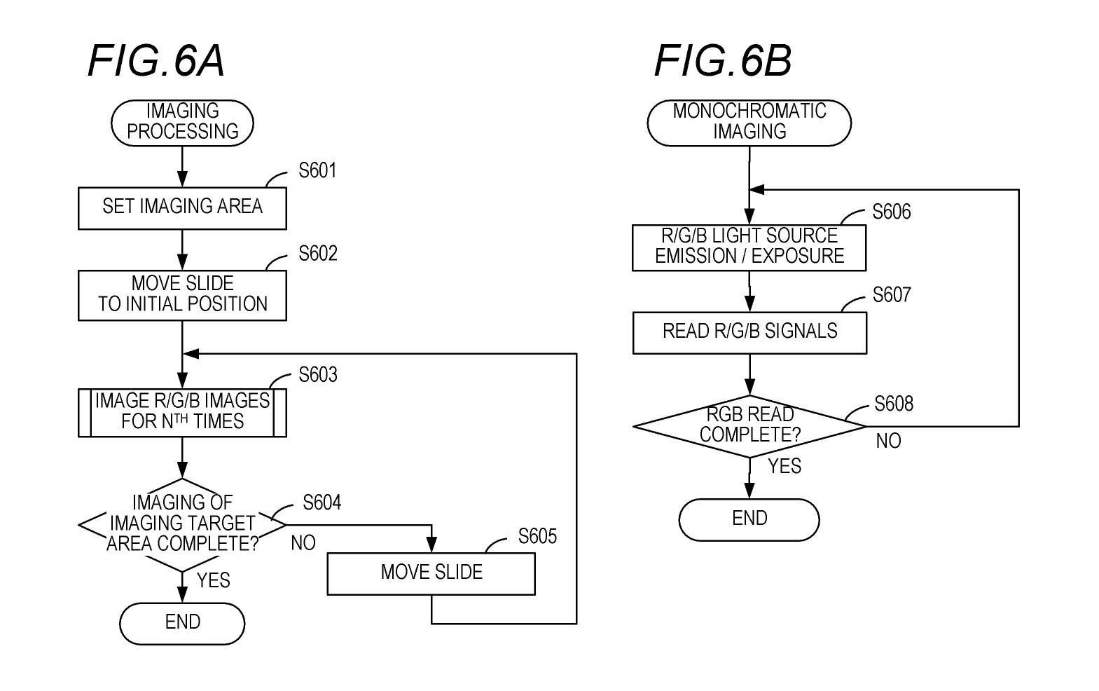

FIG. 6A is a flow chart depicting a processing to image the entire imaging target area by a plurality of times of imaging. The processing of each step to be described herein below is executed by the control unit 130 or is executed by each unit of the imaging apparatus based on instructions from the control unit 130.

In step S601, the imaging area is set. In the present embodiment, the imaging target area of a 15 mm×10 mm size is set according to the location of the test sample on the slide. The location of the test sample may be specified by the user, or may be determined automatically based on the result of measuring or imaging the slide in advance.

In step S602, the slide is moved to the initial position where the first imaging (N=1) is executed. In the case of FIG. 5B, for example, the slide is moved so that the relative position of the imaging reference area 110a and the imaging target area 501 become the state shown in (1). In the initial position, the position of the imaging reference area 110a and the position of the imaging target area 501 match.

In step S603, Nth imaging is executed within an angle of view of the lens. The image data obtained by each image sensor is sent to the development/correction unit 106 where necessary processing is performed, and is then used for merging processing in the merging unit 107. As FIG. 4 shows, the shapes of the divided areas are distorted, therefore it is necessary to extract the data on the divided area portion from the image data obtained by the image sensors, and perform aberration correction on the extracted data. The development/correction unit 106 performs these processings.

In step S604, it is determined whether imaging of the entire imaging target area is completed. If the imaging of the entire imaging target area is not completed, processing advances to S605. If the imaging of the entire imaging target area is completed, that is, if N=4 in the case of this embodiment, the processing ends.

In step S605, the moving mechanism moves the slide in order to obtain a position for executing imaging for the Nth time (N≧2). In the case of FIG. 5B, for example, the slide is moved so that the relative position of the imaging reference area 110a and the imaging target area 501 become the states shown in (2) to (4).

FIG. 6B is a flow chart depicting a more detailed processing of the imaging within an angle of view of the lens in step S603.

In step S606, emission of a monochromatic light source (R light source, G light source or B light source) and the exposure of the image sensor group are started. The lighting timing of the monochromatic light source and the exposure timing of the image sensor group are controlled to synchronize during operation.

In step S607, the single monochromatic signal (R image signal G image signal or B image signal) is read from each image sensor.

In step S608, it is determined whether imaging of all of the RGB images is completed. If imaging of each image of RGB is not completed, processing returns to S606, and processing ends if completed.

According to these processing steps, the entire imaging target area is imaged by imaging each image of RGB four times respectively.

### Advantage of this Embodiment

According to the configuration of the present embodiment described above, the arrangement and size of each two-dimensional image sensor are adjusted considering an aberration of the imaging optical system, hence image data required for image merging can be obtained using small sized two-dimensional image sensors compared with prior art. As a result, obtaining unnecessary data (data on an area unnecessary for image merging) can be minimized, hence the data volume is decreased, and the data transmission and image processing can be more efficient.

As a method for obtaining image data efficiently, a method of changing the pixel structure (shapes and arrangement of pixels) itself on the two-dimensional image sensor according to the distorted shape of the divided area can be used, besides the method of the present embodiment. This method, however, is impractical to implement, since design cost and manufacturing cost are high, and flexibility is poor. An advantage of the case of the method of the present embodiment, on the other hand, is that an unaltered general purpose two-dimensional image sensor, where identical shaped pixels are equally spaced as shown in FIG. 2B, can be used.

### Second Embodiment

A second embodiment of the present invention will now be described. The first embodiment described that it is preferable to change the size of the effective imaging area of each two-dimensional image sensor according to the shape of the individual divided area, in terms of efficient use of the effective image area. Whereas in the present embodiment, a configuration of using two-dimensional image sensors under the same specifications will be described to simplify the configuration, reduce cost and improve maintenance.

In the description of the present embodiment, detailed description on the portions the same as the above mentioned first embodiment is omitted. The general configuration of the imaging apparatus shown in FIG. 1A, the configuration of the two-dimensional image sensor shown in FIG. 2A and FIG. 2B, the aberration of the imaging optical system shown in FIG. 3A and FIG. 3B, and the procedure of the divided imaging shown in FIG. 5B, described in the first embodiment, are the same.

(Arrangement of Image Sensors)

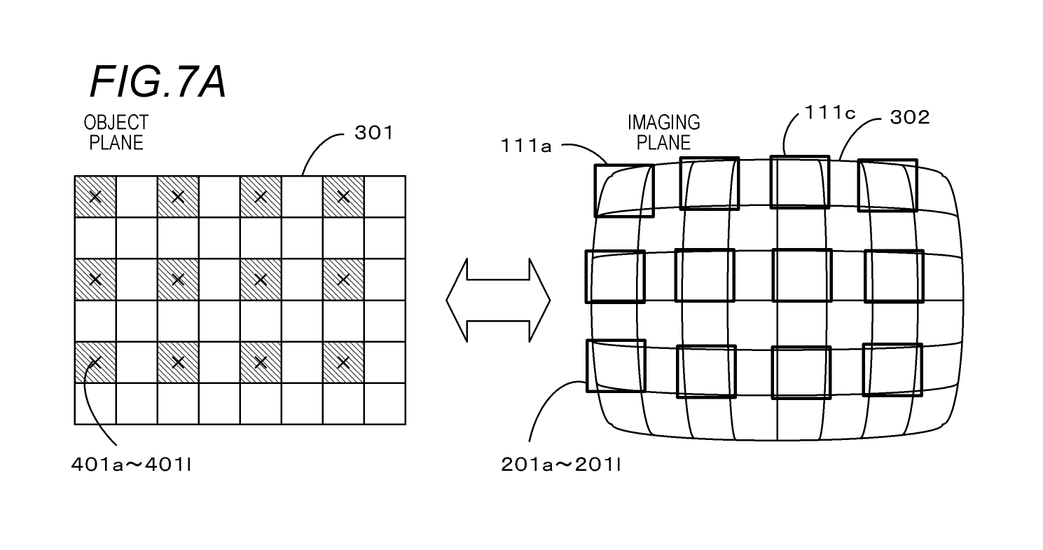

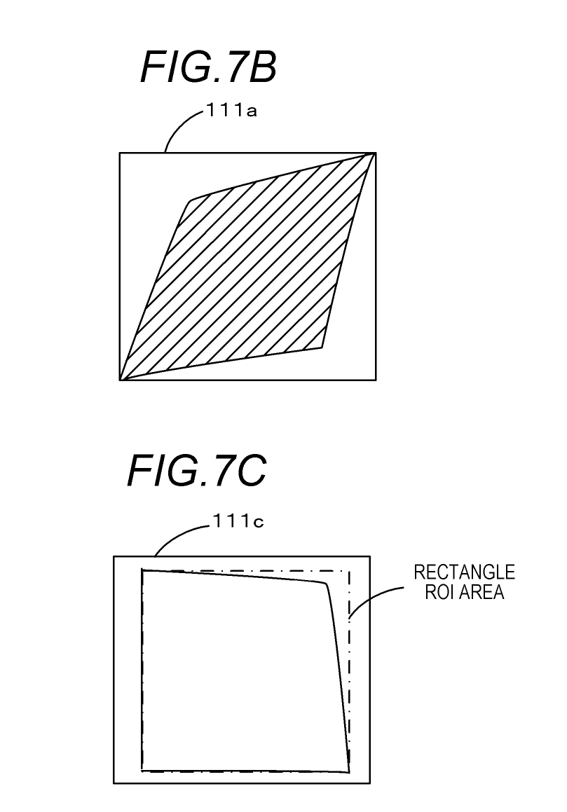

FIG. 7A to FIG. 7C are schematic diagrams depicting read areas according to distortion.

FIG. 7A is a schematic diagram depicting the arrangement of the two-dimensional image sensors considering distortion, just like FIG. 4. The object plane wire frame 301 on the object plane (on the slide) is observed on the imaging plane (on the effective image area of the two-dimensional image sensor) as the imaging plane wire frame 302 that is deformed to be barrel-shaped due to the influence of distortion. The oblique line areas on the object plane indicate divided areas to be imaged by the two-dimensional image sensors respectively. The divided areas on the object plane are equally spaced rectangles which have a same size, but on the imaging plane where the image sensor group is disposed, divided areas having deformed shapes are unequally spaced.

Now just like the first embodiment, each position of the two-dimensional image sensors is determined so that each projection center 401a to 401l, which is a center of each effective image area 201a to 201l of the two-dimensional sensor projected on the object plane, matches with the center of the corresponding divided area on the object plane. A difference from the first embodiment (FIG. 4) is that a plurality of two-dimensional image sensors of which sizes of effective image areas match (or approximately match) are used. In this configuration as well, compared with a conventional configuration where the image sensors are equally spaced (FIG. 11), the effective image area of each image sensor can be sufficiently smaller, and image data generation efficiency can be improved.

(Data Read Method)

FIG. 7B is a schematic diagram depicting random reading by a two-dimensional image sensor. Here using the image sensor 111a as an example, a case of randomly reading only the image data of the divided area in the image sensor 111a is illustrated. If the divided areas (oblique line portions) required for image merging are held as read addresses in advance, only the data on these areas can be read. Random read by the two-dimensional image sensor can be implemented by a CMOS image sensor of which reading is an XY addressing system. By holding the read address of each image sensor in a memory of the control unit in advance, only the data on the area required for image merging can be read.

FIG. 7C is a schematic diagram depicting ROI (Region Of Interest) control of a two-dimensional image sensor. Here using the image sensor 111c as an example, a case of ROI-extracted image data on the rectangular area circumscribing the divided area in the image sensor 111c is illustrated. If the dashed line area is stored as ROI in advance, only the data of this area can be read. The ROI-extraction of the two-dimensional image sensor can be implemented by a CMOS image sensor of which reading is based on an XY addressing system. By holding the ROI of each image sensor of a memory in the control unit in advance, data on the rectangular area, including an area required for image merging, can be extracted.

In the case of the method of FIG. 7B, the divided areas can be read at high precision, and only image data that contributes to image merging can be efficiently generated, but a large capacity memory for storing read addresses is necessary, and the control circuit for random reading becomes complicated and the size thereof becomes large. In the case of the method of FIG. 7C, on the other hand, the divided areas must be extracted as post-processing, but an advantage is that the circuit for reading can be simplified. Either method can be selected according to the system configuration.

The random read addresses in FIG. 7B and the ROI information in FIG. 7C can be calculated based on the design values or the measured values of distortion, and stored in memory during adjustment of the product at the factory.

Actually an overlapped area (margin) is required between the images of adjacent divided areas for the merging unit 107 to perform merging processing (connecting processing). Therefore each two-dimensional image sensor reads (extracts) data on an area having the size including this overlapped area. The overlapped area, however, is omitted here to simplify description.

(Handling of Chromatic Aberration of Magnification)

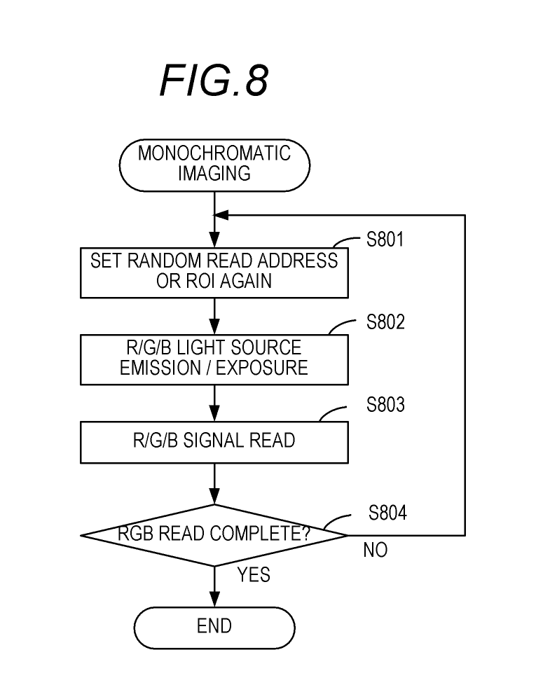

Distortion has been described thus far, and now chromatic aberration of magnification will be described with reference to FIG. 8.

As described in FIG. 3B, the positions and sizes of the divided areas on the imaging plane change depending on the color if chromatic aberration of magnification is generated. Therefore the arrangement and sizes of the effective image areas of the two-dimensional image sensors are determined so as to include all the shapes of the divided areas of R, G and B respectively. By setting the random read addresses described in FIG. 7B again, or by setting the ROI described in FIG. 7C again for each color, image data on an appropriate area can be read for each color.

FIG. 8 is a flow chart depicting reading image data according to the chromatic aberration of magnification. This corresponds to FIG. 6B of the first embodiment. The processing flow to image the entire imaging target area by a plurality of times of imaging is the same as FIG. 6A.

In step S801, a random read address or ROI is set again for each color of each image sensor. Here a read area of each image sensor is determined. The control unit holds a random read address or ROI for each color of RGB in advance, so as to correspond to the chromatic aberration of magnification described in FIG. 3B, and calls up the stored random read address or ROI to set it again. The information of the random read address for each color of RGB, or ROI for each color of RGB, is calculated based on design values or measured values, and held in memory in advance during adjustment of the at the factory.

In step S802, emission of a monochromatic light source (R light source, G light source or B light source) and exposure of the image sensor group are started. The lighting timing of the monochromatic light source and the exposure timing of the image sensor group are controlled to synchronize during operation.

In step S803, a monochromatic image signal (R image signal, G image signal or B image signal) is read from each image sensor. At this time, only the image data on a necessary area is read according to the random read address or ROI, which was set in step S801.

In step S804, it is determined whether imaging of all the RGB images is completed. If imaging of each image of RGB is not completed, processing returns to S801, and processing ends if completed.

According to these processing steps, image data, in which the shift of position and size due to chromatic aberration of magnification for each color has been corrected, can be obtained efficiently.

(Configuration for Data Read Control)

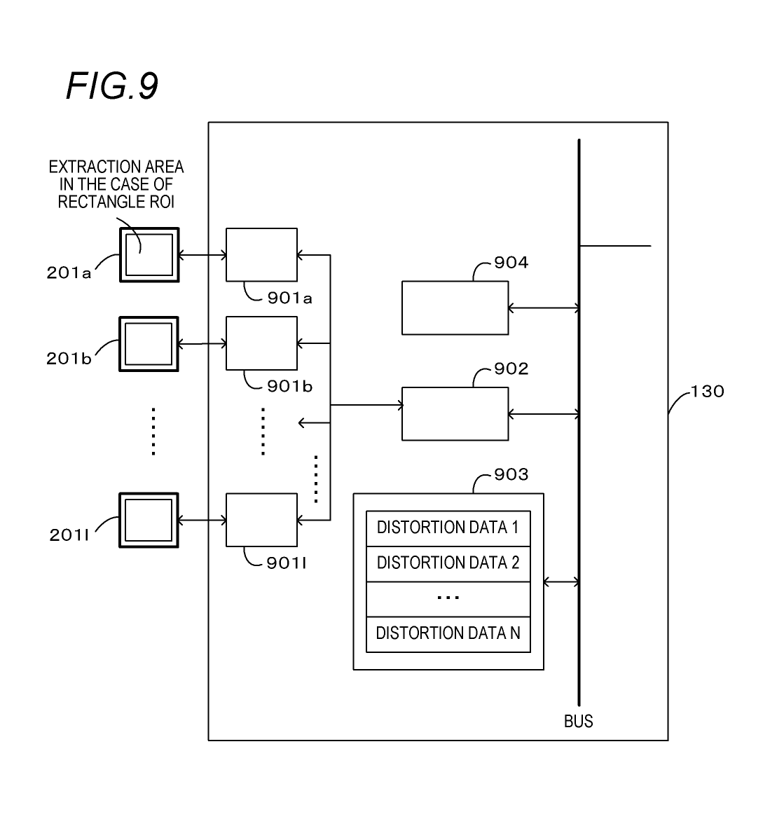

FIG. 9 is a schematic diagram depicting a configuration for electrically controlling the data read range of each image sensor. As FIG. 9 shows, the control unit 130 is comprised of imaging control units 901a to 9011 which control a read area or extraction area of each image sensor 111a to 111l, an imaging signal control unit 902, an aberration data storage unit 903 and a CPU 904.

Considering random reading and ROI control of the two-dimensional image sensors, the distortion data of the objective lens is stored in the aberration data storage unit 903 in advance. The distortion data need not be data to indicate distorted forms, but can be position data for performing random reading or ROI control, or data that can be converted into the position data. The imaging signal control unit 902 receives objective lens information for the CPU 904, and reads the corresponding distortion data of the objective lens from the aberration data storage unit 903. Then the imaging signal control unit 902 drives the imaging control units 901a to 9011 based on this distortion data which was read.

The chromatic aberration of magnification data is stored in the aberration data storage unit 903 in order to handle the chromatic aberration of magnification described in FIG. 8. The imaging signal control unit 902 receives a signal, in which imaging color (RGB) is changed, from the CPU 904, and reads the chromatic aberration of magnification data of the corresponding color (one of RGB) from the aberration data storage unit 903. Based on this chromatic aberration of magnification data which was read, the imaging signal control unit 902 drives the imaging control units 901a and 9011.

Because of the above mentioned configuration, image data can be efficiently generated by performing random reading and ROI control of the two-dimensional image sensors, even in the case of using two-dimensional image sensors having a same size effective image area. According to the configuration of the present embodiment, two-dimensional image sensors and imaging control units having same specifications can be used, hence the configuration can be simplified, cost can be reduced, and maintenance can be improved. In the configuration of the present embodiment, only necessary data is read from the image sensors, but all the data may be read from the image sensors, just like the first embodiment, and necessary data may be extracted in a post-stage (development/correction unit 106).

### Third Embodiment

In the above embodiments, distortion was considered as a static and fixed value, but in the third embodiment, distortion which changes dynamically will be considered.

If the magnification of the objective lens of the imaging optical system 104 is changed or if the objective lens itself is replaced with a new lens, for example, aberration changes due to the change of the lens shape or optical characteristics, and the shape and position of each divided area on the imaging plane change accordingly. It is also possible that the aberration of the imaging optical system 104 changes during use of the imaging apparatus, due to the change of environmental temperature and heat of the illumination light. Therefore it is preferable that a sensor to detect the change of magnification of the imaging optical system 104 or replacement of the lens, or a sensor to measure the temperature of the imaging optical system 104 is installed, so as to adaptively handle the change of the aberration based on the detection result.

In concrete terms, in the configuration shown in FIG. 9, the data read range of each image sensor may be electrically changed according to the deformation or displacement of each divided area caused by aberration after the changes. Each image sensor may be mechanically rearranged according to the deformation or displacement of each divided area caused by aberration after the changes. The configuration to mechanically rearrange each image sensor (position adjustment unit) can be implemented by controlling the position or rotation of each image sensor using piezo-driving or motor driving of the XYθ stage, which is used for standard microscopes. In this case as well, the same mechanical driving mechanism can be used by using a plurality of two-dimensional image sensors of which effective image areas are approximately the same size, whereby the configuration can be simplified. It is assumed that the position center and size of each two-dimensional image sensor are calculated depending on the conditions of the objective lens, such as magnification, type and temperature, based on the design values or measured values of the objective lens, and arrangement of each two-dimensional image sensor under each condition is stored in the memory in advance upon adjustment of the product at the factory.

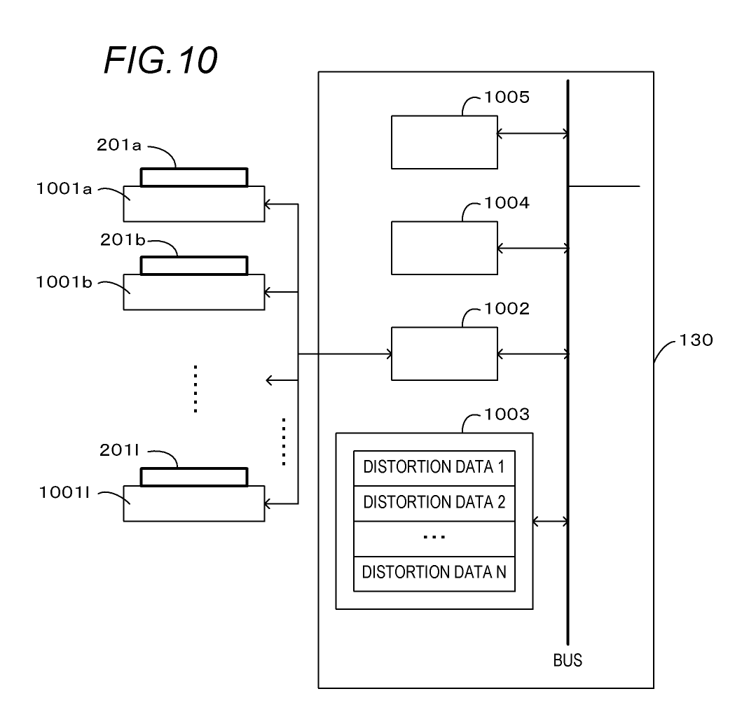

An example of the configuration to mechanically rearrange each image sensor according to the change of magnification or replacement of the objective lens will be described with reference to FIG. 10. In the imaging unit 105, the XYθ stages 1001a to 1001l are disposed for the image sensors 111a to 111l respectively. By the XYθ stages 1001a to 1001l, the effective image area of each image sensor 111a to 111l can parallel-shift in the X direction and Y direction, and rotate around the Z axis. The control unit 130 has an XYθ stage control unit 1002, an aberration data storage unit 1003, a CPU 1004 and a lens detection unit 1005.

Distortion data for each magnification of the objective lens and for each type of the objective lens are stored in the aberration data storage unit 1003. The distortion data need not be data to indicate the distorted forms, but can be position data for driving the XYθ stage or data that can be converted into the position data. The lens detection unit 1005 detects the change of the objective lens, and notifies the change to the CPU 1004. Receiving the signal notifying the change of the objective lens from the CPU 1004, the XYθ stage control unit 1002 reads the corresponding distortion data of the objective lens from the aberration data storage unit 1003. Then the XYθ stage control unit 1002 drives the XYθ stages 1001a to 1001l based on this distortion data which was read.

According to the configuration of the present embodiment described above, image data required for image merging can be generated efficiently, just like the first and second embodiments. In addition, when the objective lens is changed, the change of distortion caused by changing magnification or replacing lenses, can be handled by adaptively changing the arrangement of the two-dimensional image sensors. Since the two-dimensional image sensors, which have approximately the same size effective image area, are used as an image sensor group, a same mechanism can be used for the moving control mechanism of each two-dimensional image sensor, and the configuration can be simplified, and cost can be reduced.

In order to handle the change of aberrations depending on temperature, a temperature sensor for measuring the temperature of the lens barrel of the imaging optical system 104 may be disposed in the configuration in FIG. 9 or FIG. 10, so that the data read range of the image sensors can be changed or the positions of the image sensor can be adjusted according to the measured temperature.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-273386, filed on Dec. 8, 2010 and Japanese Patent Application No. 2011-183091, filed on Aug. 24, 2011, which are hereby incorporated by reference herein in their entirety.

What is claimed is:

1. An imaging apparatus which, with an imaging target area of an object being divided into a plurality of areas, images each of the divided areas using a two-dimensional image sensor,
the apparatus comprising:
a plurality of two-dimensional image sensors which are discretely disposed;
an imaging optical system which enlarges an image of the object and forms an image thereof on an imaging plane of the plurality of two-dimensional image sensors; and
a moving unit which moves the object in order to execute a plurality of times of imaging while changing the divided area to be imaged by each of the two-dimensional image sensors, wherein
at least a part of the plurality of divided areas is deformed or displaced on the imaging plane due to aberration of the imaging optical system, and
each position of the plurality of two-dimensional image sensors is adjusted according to a shape and position of the corresponding divided area on the imaging plane.

2. The imaging apparatus according to claim 1, wherein a plurality of two-dimensional image sensors, corresponding to a plurality of equally spaced divided areas respectively on an object plane of the object, are unequally spaced on the imaging plane.

3. The imaging apparatus according to claim 1, wherein
each position of the plurality of two-dimensional image sensors is adjusted so that the center of projection, which is a point of the center of the two-dimensional image sensor projected onto the object plane of the object, matches with the center of the corresponding divided area on the object plane.

4. The imaging apparatus according to claim 1, wherein the sizes of the plurality of two-dimensional image sensors are different depending on the size of a circumscribed rectangle of the corresponding divided area on the imaging plane.

5. The imaging apparatus according to claim 1, wherein
the plurality of two-dimensional sensors are produced under same specifications.

6. The imaging apparatus according to claim 1, wherein a pixel structure of each of the two-dimensional image sensors has identically shaped pixels that are equally spaced.

7. The imaging apparatus according to claim 1, further comprising a read control unit which controls a data read range of each of the two-dimensional image sensors, so that only data in a range in accordance with the corresponding divided area is read from each of the two dimensional sensors.

8. The imaging apparatus according to claim 7, wherein
when the aberration of the imaging optical system is changed, the read control unit changes the data read range of each of the two-dimensional image sensors according to deformation or displacement of each divided area due to the aberration after change.

9. The imaging apparatus according to claim 8, further comprising a detection unit which detects a magnification change or lens replacement in the imaging optical system, wherein
the read control unit determines that aberration of the imaging optical system has changed when the detection unit detects a magnification change or lens replacement in the imaging optical system.

10. The imaging apparatus according to claim 8, further comprising a measurement unit which measures a temperature of the imaging optical system, wherein
the read control unit determines the change of aberration in the imaging optical system based on the measured temperature by the measurement unit.

11. The imaging apparatus according to claim 1, further comprising a position adjustment unit which, when aberration of the imaging optical system changes, changes a position of each of the two-dimensional image sensors according to the deformation or displacement of each divided area due to the aberration after change.

12. The imaging apparatus according to claim 11, further comprising a detection unit which detects a magnification change or lens replacement in the imaging optical system, wherein
the position adjustment unit determines that the aberration of the imaging optical system has changed when the detection unit detects a magnification change or lens replacement in the imaging optical system.

13. The imaging apparatus according to claim 11, further comprising a measurement unit which measures a temperature of the imaging optical system, wherein
the position adjustment unit determines the change of aberration in the imaging optical system based on the measured temperature by the measurement unit.

14. The imaging apparatus according to claim 1, wherein the aberration of the imaging optical system is distortion or chromatic aberration of magnification.

15. The imaging apparatus according to claim 1, wherein the position and size of the two-dimensional image sensor are a position and size of an effective image area, which is an area where effective pixels of the two-dimensional image sensor are disposed.

16. An imaging apparatus which, with an imaging target area of an object being divided into a plurality of areas, images each of the divided areas using a two-dimensional image sensor, comprising:
a plurality of two-dimensional image sensors which are discretely disposed;
an imaging optical system which enlarges an image of the object and forms an image thereof on an imaging plane of the plurality of two-dimensional image sensors;
a moving unit which moves the object in order to execute a plurality of times of imaging while changing the divided area to be imaged by each of the two-dimensional image sensors, and
a position adjustment unit which adjusts each position of the plurality of two-dimensional image sensors, wherein
at least a part of the plurality of divided areas is deformed or displaced on the imaging plane due to aberration of the imaging optical system, and
when aberration of the imaging optical system changes, the position adjustment unit changes a position of each of the two-dimensional image sensors according to the deformation or displacement of each divided area due to the aberration after change.
